(19) United States
(12) Patent Application Publication
(10) Pub. No.: US 2008/0244442 A1
(43) Pub. Date: Oct. 2, 2008

(54) Techniques to share information between application programs

(75) Inventors: Olya Veselova, Redmond, WA (US); David Garber, Bellevue, WA (US); Ryan Gregg, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/731,512

(22) Filed: Mar. 30, 2007

(51) Int. Cl. G06F 3/048

(52) U.S. Cl. 715/781

(57) ABSTRACT

Techniques to share information between application programs are described. An apparatus may comprise a first application program to create notes for an operator, and a second application program to display a target item. The apparatus may further include a note interface module to associate the note with the target item, and display a visual indicator on the target item indicating whether a note is associated with the target item. Other embodiments are described and claimed.

### BACKGROUND

User information may be created and maintained using many different application programs and systems. In some cases, information from one application program may be made available to another application program, essentially becoming shared information. For example, a word processing application program may be used to generate a word processing document containing embedded spreadsheet information maintained by a separate spreadsheet application. As modifications are made to the spreadsheet information, the modifications are automatically replicated to the embedded spreadsheet information in a dynamic manner. Since shared information is managed by multiple application programs, however, accessing shared information from one or more application programs could be inefficient or cumbersome from a user perspective. Consequently, there may be a need for improved techniques for managing and accessing shared information between multiple application programs in an efficient and effective manner to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques for sharing information between application programs. Some embodiments are particularly directed to techniques for accessing information from one application program that is managed or maintained by another application program. In one embodiment, for example, an apparatus such as a computing device or system may include a first application program to create information in the form of notes for an operator or user. A second application program may be used to generate or display a target item. A note interface module may be arranged to associate one or more notes with the target item, and display a visual indicator on the target item indicating whether any notes have been associated with the target item. The visual indicator or indicators may be used to convey state information to an operator. For example, the visual indicator may have one state to indicate that one or more notes have been associated with the target item, and another state to indicate that no notes have been associated with the target item. The operator may use the visual indicator to open a note view while maintaining a context for the second application program. In this manner, an operator may be provided a consistent user experience when accessing or viewing the shared information. Other embodiments are described and claimed.

### BRIEF DESCRIPTION OF THE DRAWINGS

FIG. 1 illustrates one embodiment of a computing system.

FIG. 2 illustrates one embodiment of shared information.

FIG. 3 illustrates one embodiment of a logic flow.

FIG. 4 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

Various embodiments may be directed to techniques to improve sharing information between multiple application programs. For example, a computing device may include a first application program to create information such as notes for an operator, and a second application program to generate or display a target item. In one embodiment, for example, the first and second application programs may be from the MICROSOFT® OFFICE suite of application programs, made by Microsoft Corporation, Redmond, Wash. An example of a first application program may include, but is not limited to, a MICROSOFT OFFICE ONENOTE® application program, usually referred to as MICROSOFT ONENOTE. An example of a second application program may include, but is not limited to, a MICROSOFT OFFICE OUTLOOK® application program, usually referred to as MICROSOFT OUTLOOK.

Various embodiments may include a note interface module. The note interface module may be arranged to manage information shared or associated between the first and second application programs. For example, the note interface may be arranged to associate one or more notes created and managed by MICROSOFT ONENOTE with a target item from MICROSOFT OUTLOOK, such as a task item, a calendar item, a contact item, an email item, a meeting item, and so forth. The note interface module may display a visual indicator, such as a custom indicator icon or symbol, on the target item indicating whether any notes have been associated with the target item. The visual indicator may have one state to indicate that one or more notes have been associated with the target item, and another state to indicate that there are no notes associated with the target item. As a result, an operator may quickly assess whether additional exploration or navigation is needed to retrieve notes with an item.

Various embodiments may maintain a user context or consistent user view for the information shared or associated between the application programs. The operator may use the visual indicator, such as by clicking on an icon, to open a note view while maintaining a user context for the second application program. For example, a graphic user interface (GUI) window may be opened to display the note. The new GUI window may be superimposed on the GUI window used to display the MICROSOFT OUTLOOK application program or a target item, or both windows may be sized to allow an operator to view both windows on a given screen or display. In this manner, an operator may be provided a consistent user experience when accessing or viewing the shared information.

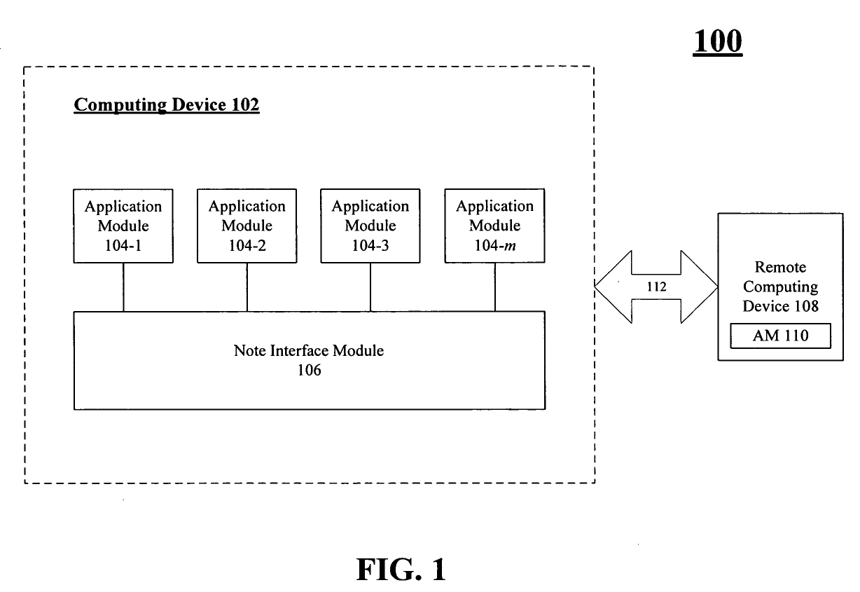

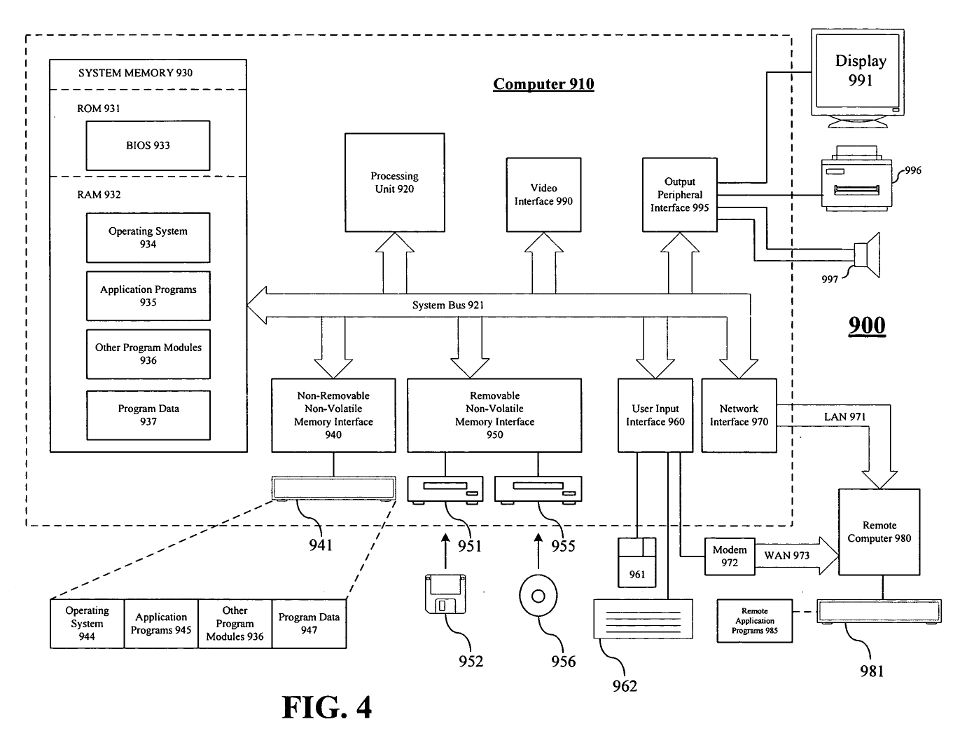

FIG. 1 illustrates a block diagram of a computing system 100. The computing system 100 may represent any computing system, architecture, or infrastructure arranged to store, process, communicate, and otherwise manage shared or associated information processes or operations for an electronic system or collection of electronic systems. As shown in FIG. 1, one embodiment of the computing system 100 may include a computing device 102 coupled to one or more remote computing devices 108. Computing device 102 may comprise two or more application modules 104-1-m coupled to a note interface module 106. Remote computing device 108 may include an application module 110. In some cases, the modules 104, 110 may be the same or similar modules. In other cases, the modules 104, 110 may be arranged as client-server applications or peer-to-peer applications as desired for a given implementation. Additional details for one embodiment of computing device 102 and remote computing device 108 may be further illustrated and described with reference to FIG. 4.

As used herein the term “module” may include any structure implemented using hardware elements, software elements, or a combination of hardware and software elements. In one embodiment, for example, the modules described herein are typically implemented as software elements stored in memory and executed by a processor to perform certain defined operations. It may be appreciated that the defined operations may be implemented using more or less modules as desired for a given implementation. It may be further appreciated that the defined operations may be implemented using hardware elements based on various design and performance constraints. The embodiments are not limited in this context.

In various embodiments, the computing system 100 may be used to store, process, communicate, and otherwise manage shared information processes or operations between application programs 104-1-m and/or 110. With respect to computing device 102 and/or remote computing device 108, the note interface module 106, the application programs 104-1-m and 110, and/or any shared or associated information may be stored and accessed via any number of memory units, storage media, machine readable media, or computer-readable media implemented for a given computing device. Computing device 102 and remote computing device 108 may represent any type of electronic device having the appropriate hardware, software or combination hardware and software arranged to execute the operations of the application modules 104-1-m, the note interface module 106, and/or the application module 110.

In various embodiments, the note interface module 106 may allow the application modules 104-1-m and/or 110 to efficiently share information, such as note information or notes. For example, assume the application module 104-1 is implemented as a MICROSOFT ONENOTE application program. The MICROSOFT ONENOTE application program is a tool for taking notes, information gathering, and multi-user collaboration. The notes may be categorized together into notebooks. The note interface module 106 may allow the notes from the application module 104-1 to be shared by one or more of the other application programs 104-2-m. For example, assume the application module 104-2 is implemented as a MICROSOFT OUTLOOK application program. The MICROSOFT OUTLOOK application program is a personal information manager (PIM) that can be used to manage email, a calendar, tasks, contact management, note taking, and a journal. As a PIM, the application program 104-2 may have numerous target items, such as task items, calendar items, contact items, email items, meeting items, and so forth. The note interface module 106 may allow notes managed by the application module 104-1 to be associated with one or more of the various target items managed by the application module 104-2. For example, a user note for a meeting agenda may be associated with a calendar item having a meeting date and time.

In some cases, however, it may be difficult or cumbersome for a user to determine or assess whether a note from the application module 104-1 has been associated with a given target item of the application module 104-2. For example, assume the user takes notes on some future task clarifying what needs to be done, or makes a check-list of items that should not be forgotten as part of that task. In a week or two, when the user views the task item in the “To Do” bar or calendar well for the application program 104-1, the user may forget that more information is available. For meetings this might be an issue if the user takes advance agenda notes several days before the meeting and then forgets to look at them during the meeting.

Various embodiments attempt to solve these and other problems. The note interface module 106 may implement various techniques or provide various application program interfaces (API) to allow a user to create notes with the application program 104-1, associate the notes with particular target items for the application program 104-2 (or other application programs), and view the associated notes. Further, the note interface module 106 may allow a user to remain in the user context or user experience of the application program 104-2 while creating, associating and viewing the notes using the application program 104-1. For example, from within the user experience and GUI of the application program 104-2, a user can take notes on various tasks or items. When the user creates notes on an item using the application program 104-2, the user can pick the location where the notes should go in the storage or folder hierarchy of the application program 104-1. In addition to creating and associating new notes with a target item, a user can associate existing notes with various target items. The notes can be taken or viewed while still looking at the GUI for the application program 104-2.

It is worthy to note that shared notes may be stored locally by the computing device 102, or remotely by the remote computing device 108, and still fall within the scope of the embodiments. For example, the remote computing device 108 may be implemented as a network server accessible to the application programs 104-1 and/or 104-2 via a wired or wireless network connection. The embodiments are not limited in this context.

In general operation, the availability of notes managed by the application program 104-1 for any given item managed by the application program 104-2 is visible in the application program 104-2 without the need to open the item, hover over it, or select it. This may be accomplished using various types of visual indicators that are displayed on the target item. Examples of visual indicators may include without limitation any type of graphic, image, icon, symbol, animation, picture, photograph, digital image, or any other visible cue to the user. The user can open the associated notes in one click using the visual indicator. When the user clicks the visual indicator for the target item of the application program 104-2, the note interface module 106 follows this logic to locate the item in the application program 104-1.

In one embodiment, for example, the note interface module 106 may display one or more visual indicators on the target item indicating whether a note is associated with the target item. The visual indicators may have one state to indicate that one or more notes have been associated with the target item, and another state to indicate that there are no notes associated with the target item. For example, a visual indicator may comprise a custom indicator icon, with the presence of additional features on the custom indicator icon indicating associated notes, and the absence of additional features on the custom indicator icon indicating no associated notes. An example of such a distinguishing feature may be the rendering of an icon with a feature appearing as a “linked chain” on the icon to indicate the first state, and the absence of the linked chain on the icon to indicate the second state. In another example, the visual indicator may comprise multiple custom indicator icons, with a first custom indicator icon representing the first state and the second custom indictor icon representing the second state. It may be appreciated that the use of a single visual indicator or multiple visual indicators is not limited as long as the implementation conveys multiple states representing different types of information to the operator. Further, the multiple states may be implemented using any number of visual indicators rendered in real-time or retrieved from storage media. The embodiments are not limited in this context.

In one embodiment, for example, the application program 104-2 may provide an object model method that allows a custom indicator icon to be rendered on the target items. The indicator will be rendered or not rendered based on the value of a special property that the application program 104-2 will add or allow the note interface module 106 to add as part of the object model method.

In one embodiment, for example, the note interface module 106 may be arranged to detect whether the target item has been selected, retrieve a globally unique identifier (GUID) for the target item, and determine whether any notes from the first application program are associated with the target item. In order for the application program 104-1 to keep track of associated notes for the application program 104-2, the note interface module 106 may generate a GUID for a note as a custom property. The application program 104-2 may store the GUID as textual property so it gets indexed and a fast lookup may be performed by a search service, such as a MICROSOFT WINDOWS® Desktop Search (WDS) service, for example. The application program 104-2 should have support for quick lookup of non-text based custom properties to facilitate such operations. The application program 104-2 may also store a hyperlink to the associated page in case the notebook for the application program 104-1 is not open on the computing device 102. The note interface module 106 may also set a property that causes the visual indicator to be rendered in the application program 104-2.

For the associated notes, the application program 104-1 may store one or more GUID that were stored in the target item for the application program 104-2. In addition, the application program 104-1 may store an item ID for the target item to improve efficiency. Additional information may also be stored with the notes to assist in locating the notes if they cannot be found by GUID or item ID, such as key words, context cues, and so forth. One or more links back to the target item, or task flags, may be stored with the notes to allow a user to navigate back to the target item.

In order to navigate from the application program 104-2 to the application program 104-1 when a user clicks on, hovers above or otherwise selects the visual indicator, the note interface module 106 utilizes the following logic to locate the note in the application program 104-1. The application program 104-1 may look for a notebook page that contains the GUID stored with the target item. If the page is not found, the application program 104-1 uses the hyperlink stored with the target item. If a user roams a list of open notebooks for the application program 104-1 via the GUI of the application program 104-2, the note interface module 106 could offer to open and search any notebooks that are not currently open. If the GUID or hyperlink target cannot be found, the note interface module 106 may display an error message, such as:
“OneNote cannot find the notes associated with this item. They may be in a notebook that is not currently open, or they may have been deleted. Do you want to remove the note link from the Outlook item?”

In order to navigate from the application program 104-1 to the application program 104-2, the note interface module 106 may use a special task GUID to look for the task or item in the application program 104-2. For other items, if the user clicks on the “Link back to Outlook” hyperlink, the application program 104-1 will: (1) use WDS to retrieve the target item containing the GUID and get the item ID, or if the target item is not found in WDS, use the item ID stored in the application program 104-1; (2) retrieve the target item by item ID; and (3) once the target item is found, open its inspector. If the target item cannot be found by item ID, and it happens to be a meeting item, it is possible that the user is clicking the link on a meeting notes page taken by some other user in a shared notebook. It may still be valuable to try to locate the current user's copy of the meeting in the application program 104-2. The note interface module 106 will search by meeting title and date and time. If the target item is found, the application program 104-1 will insert the association with the notes into that item. If the target item cannot be found by item ID, the note interface module 106 may display an error message, such as:
“OneNote cannot find the Outlook item. It may have been deleted from Outlook, or it belongs to another user.”

In various embodiments, the node interface module 106 may be used to perform periodic synchronization operations to determine the existence of associated notes between the application programs 104-1, 104-2. For example, the application program 104-1 may perform periodic synchronization operations with the application program 104-2 to restore missing or corrupted note links in the target items. An example of the latter case is when the custom property in the target item somehow gets deleted or corrupted. An example of the former case is when another user has taken meeting notes in a shared notebook, and the note interface module 106 can show the note indicator on the meeting instance of the current user. It is worthy to note that the note interface module 106 typically does not use synchronization operations to remove indicators for deleted notes, because of the difficulty involved in differentiating deletion from notes being moved to some currently closed shared notebook.

The synchronization operations may be performed, for example, after a defined time period of deep idle when the computing device 102 is not in use. The synchronization operations may occur at any desired time interval, although once per day may typically be sufficient for many applications. To initiate synchronization operations, the note interface module 106 may retrieve the list of all pages that are associated with target items. For each item, the note interface module 106 may call the application program 104-2 and find the corresponding target item. If the target item is a task, the note interface module 106 will update the task state in the application program 104-1 to match the task state of the application program 104-2. If the target item is not found by GUID or item ID, the note interface module 106 will attempt to find it by subject, and date and time for meeting occurrences. If the item is found and does not have association with the application program 104-1, the note interface module 106 will add the appropriate association. If the application program 104-2 had to be started in order to perform the synchronization operations, it will be shut down after the synchronization operations are finished.

In one embodiment, for example, the note interface module 106 may be arranged to receive an operator instruction selecting the visual indicator, and display the note using a separate note view displayed substantially simultaneously with a target item view for the second application program. The operator may use the visual indicator, such as by clicking on an icon, to open a note view while maintaining a context for the second application program. For example, a new GUI window may be opened to display the note. The new GUI window may be superimposed on the GUI window used to display the application program 104-2 or a target item for the application program 104-2. Alternatively, both windows may be automatically sized to allow an operator to view both windows on a given screen or display. For example, when the user takes/views notes on a target item, the notes may be displayed in a docked-to-desktop GUI window, which can then be maximized if desired. The note interface module 106 should be able to cause the notes to be created or opened in the docked note view GUI window. The note interface module 106 may open the docked window if not already opened, and if the user has not disabled the note view feature to be opened in docket window mode. The note interface module 106 may navigate to the page with the given ID in the docked ON window.

Operations for the computing system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the computing system 100 or alternative elements as desired for a given set of design and performance constraints.

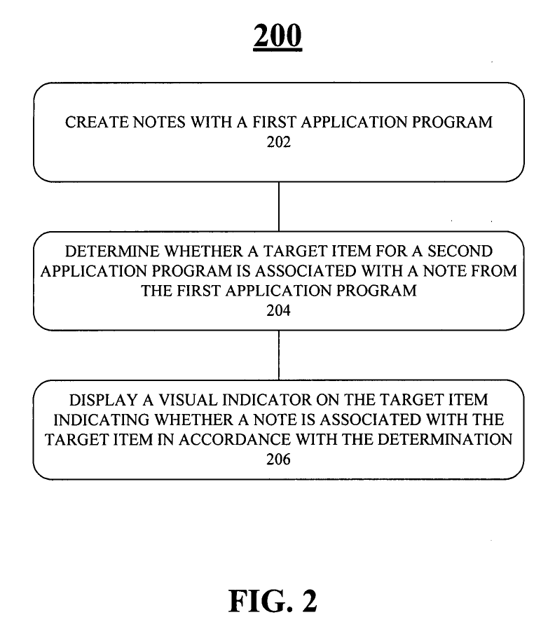

FIG. 2 illustrates a logic flow 200. The logic flow 200 may be representative of the operations executed by one or more embodiments described herein. As shown in FIG. 2, the logic flow 200 may create notes with a first application program at block 202. The logic flow 200 may determine whether a target item for a second application program is associated with a note from the first application program at block 204. The logic flow 200 may display a visual indicator on the target item indicating whether a note is associated with the target item in accordance with the determination at block 206. The embodiments are not limited in this context.

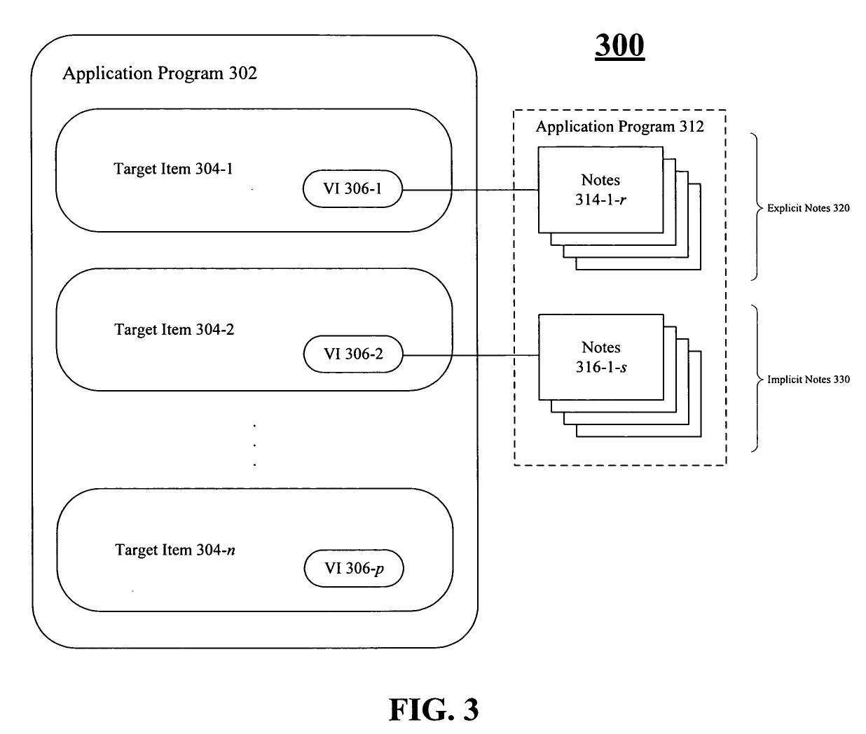

FIG. 3 illustrates a logic diagram 300. The logic diagram 300 illustrates application programs 302, 312. The application programs 302, 312 may be representative of one or more of the application programs 104-1-m and/or 110, such as the application programs represented by the respective application modules 104-1, 104-2. The application program 302 may have multiple target items 304-1-n. The target items 304-1-n may represent individual items or objects for the application program 302. The target items 304-1-n may each include respective visual indicators 306-1-p. In one embodiment, for example, the visual indicators 306-1-p may comprise custom indicator icons of varying sizes, shapes, colors, content, and so forth.

In one embodiment, for example, an operator may create notes with the application program 312 directly from the application program 312 or via the application program 302. The application program 302 or the note interface module 106 may determine whether a target item 304-1-n for the application program 302 is associated with a note from the application program 312. The application program 302 or the note interface module 106 may display a visual indicator on the target item 304-1-n indicating whether a note is associated with the target item 304-1-n in accordance with the previous determination.

As shown in FIG. 3, a target item such as the target items 304-1, 304-2 may each include a visual indicator such as the respective visual indicators 306-1, 306-2. The visual indicators 306-1, 306-2 may be located on a graphic or view for the respective target items 304-1, 304-2, thereby allowing an operator to easily view the visual indicators 306-1, 306-2 without necessarily opening the target items 304-1, 304-2 and switching the user context or user view.

In one embodiment, for example, the visual indicator 306-1 may have a first state indicating one or more notes 314-1-r as managed by the application program 312 are associated with the target item 304-1. The visual indicator 306-1 may also have a second state in the event there are no notes associated with the target item 304-1. Similarly, the visual indicator 306-2 may have a first and second state indicating whether one or more notes 316-1-s as managed by the application program 312 have been associated with the target item 304-2. As previously described, the different states may imply different visual indicators, with the different visual indicators modifying one or more of a size dimension, shape dimension, color dimension, content dimension, and so forth. Any type or number of visual indicators may be used as long as the implementation conveys different states, with each state indicating whether any notes have been associated with a given target item.

In various embodiments, an operator may access a note for a target item using the visual indicator. As shown in FIG. 3, the note interface module 106 may be used to associate the given set of notes 314-1-r with the target item 304-1 of the application program 302, and the given set of notes 316-1-s with the target item 304-2 of the application program 302. In order to access the respective set of notes 314, 316, an operator can click on, hover above, or otherwise select the appropriate visual indicator 306-1, 306-2. The note interface module 106 may receive the operator selection, and generate a note view to display a note associated with the target item while maintaining a context for the second application program.

In various embodiments, the note interface module 106 may generate a note view to display a first set of notes explicitly associated with the target item. For example, the note interface module 106 may generate a note view to display the notes 314-1-r as a set of explicit notes 320. The explicit notes 320 may include those notes that have been explicitly associated with the target item 304-1 by an operator. The operator may create a note for the target item 304-1 by selecting the target item 304-1 and selecting a create note button for the application program 302, selecting the visual indicator 306-1, using a GUI for the application program 312, or some other technique. The operator may then associate the newly created note with the target item 304-1. Alternatively, the operator may open a notebook for the application program 312 via the GUI for the application program 302 or the application program 312, select a previously created note, and associate the selected note with the target item 304-1.

In various embodiments, the note interface module 106 may generate a note view to display a second set of notes implicitly associated with the target item. For example, the note interface module 106 may generate a note view to display the notes 316-1-s as a set of implicit notes 330. The implicit notes 330 may include those notes that have been implicitly associated with the target item 304-2 in accordance with a set of implicit association rules. Examples of implicit association rules may include searching for notes having similar key words, user identifiers, time/data information, application identifiers, heuristics, and any other rules providing intelligent grouping of notes. The search results may then be associated with the target item 304-2 as the implicit notes 330 comprising the notes 316-1-s.

FIG. 4 illustrates a block diagram of a computing system architecture 900 suitable for implementing various embodiments, including the computing system 100. It may be appreciated that the computing system architecture 900 is only one example of a suitable computing environment and is not intended to suggest any limitation as to the scope of use or functionality of the embodiments. Neither should the computing system architecture 900 be interpreted as having any dependency or requirement relating to any one or combination of components illustrated in the exemplary computing system architecture 900.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 4, the computing system architecture 900 includes a general purpose computing device such as a computer 910. The computer 910 may include various components typically found in a computer or processing system. Some illustrative components of computer 910 may include, but are not limited to, a processing unit 920 and a memory unit 930.

In one embodiment, for example, the computer 910 may include one or more processing units 920. A processing unit 920 may comprise any hardware element or software element arranged to process information or data. Some examples of the processing unit 920 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 920 may be implemented as a general purpose processor. Alternatively, the processing unit 920 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 910 may include one or more memory units 930 coupled to the processing unit 920. A memory unit 930 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 910. The embodiments are not limited in this context.

In one embodiment, for example, the computer 910 may include a system bus 921 that couples various system components including the memory unit 930 to the processing unit 920. A system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 910 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 900. Examples of computer readable media for computing system architecture 900 may include, but are not limited to, volatile and/or nonvolatile memory such as ROM 931 and RAM 932. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 930 includes computer storage media in the form of volatile and/or nonvolatile memory such as ROM 931 and RAM 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 4 illustrates operating system 934, application programs 935, other program modules 936, and program data 937.

The computer 910 may also include other removable/non-removable, volatile/nonvolatile computer storage media. By way of example only, FIG. 4 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 4, provide storage of computer readable instructions, data structures, program modules and other data for the computer 910. In FIG. 4, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor 991, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer (PC), a server, a router, a network PC, a peer device or other common network node, and typically includes many or all of the elements described above relative to the computer 910, although only a memory storage device 981 has been illustrated in FIG. 4 for clarity. The logical connections depicted in FIG. 4 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other technique suitable for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 4 illustrates remote application programs 985 as residing on memory device 981. It will be appreciated that the network connections shown are exemplary and other techniques for establishing a communications link between the computers may be used. Further, the network connections may be implemented as wired or wireless connections. In the latter case, the computing system architecture 900 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system 100 and/or computing system architecture 900 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
creating notes with a first application program;
determining whether a target item for a second application program is associated with a note from the first application program; and
displaying a visual indicator on the target item indicating whether a note is associated with the target item in accordance with the determination.

2. The method of claim 1, comprising displaying the visual indicator on the target item with a first state indicating a note is associated with the target item.

3. The method of claim 1, comprising displaying the visual indicator on the target item with a second state indicating a note is not associated with the target item.

4. The method of claim 1, comprising associating a note with the target item for the second application program.

5. The method of claim 1, comprising accessing the note using the visual indicator.

6. The method of claim 1, comprising generating a note view to display a note associated with the target item while maintaining a context for the second application program.

7. The method of claim 1, comprising generating a note view to display a first set of notes explicitly associated with the target item.

8. The method of claim 1, comprising generating a note view to display a second set of notes implicitly associated with the target item.

9. An article comprising a storage medium containing instructions that if executed enable a system to:
create a note with a first application program;
associate the note with a target item for a second application program; and
display a visual indicator on the target item with a first state indicating the note is associated with the target item.

10. The article of claim 9, further comprising instructions that if executed enable the system to display the visual indicator on the target item with a second state indicating a note is not associated with the target item.

11. The article of claim 9, further comprising instructions that if executed enable the system to access the note by selecting the visual indicator.

12. The article of claim 9, further comprising instructions that if executed enable the system to generate a note view to display the note associated with the target item while maintaining a context for the second application program.

13. The article of claim 9, further comprising instructions that if executed enable the system to generate a note view to display a first set of notes explicitly associated with the target item.

14. The article of claim 9, further comprising instructions that if executed enable the system to generate a note view to display a second set of notes implicitly associated with the target item.

15. The article of claim 9, further comprising instructions that if executed enable the system to display the note from within the second application program in response to an operator instruction.

16. An apparatus comprising:
a first application program to create notes for an operator;
a second application program to display a target item; and
a note interface module to associate the note with the target item, and display a visual indicator on the target item indicating whether a note is associated with the target item.

17. The apparatus of claim 16, the note interface module to display a visual indicator on the target item with a first state indicating a note is associated with the target item.

18. The apparatus of claim 16, the note interface module to display a visual indicator on the target item with a second state indicating a note is not associated with the target item.

19. The apparatus of claim 16, the note interface module to detect whether the target item has been selected, retrieve a globally unique identifier for the target item, and determine whether any notes from the first application program are associated with the target item.

20. The apparatus of claim 16, the note interface module to receive an operator instruction selecting the visual indicator, and display the note using a separate note view displayed substantially simultaneously with a target item view for the second application program.
